(19) United States
(12) Patent Application Publication
(10) Pub. No.: US 2019/0385337 A1
(43) Pub. Date: Dec. 19, 2019

(54) ARTICLE POSITIONING METHOD AND SYSTEM

(71) Applicant: CLOUDMINDS (SHENZHEN) ROBOTICS SYSTEMS CO., LTD., Guangdong (CN)

(72) Inventor: Zhanchao ZHANG, Guangdong (CN)

(21) Appl. No.: 16/556,073

(22) Filed: Aug. 29, 2019

Related U.S. Application Data
(63) Continuation of application No. PCT/CN2018/079602, filed on Mar. 20, 2018.

(51) Int. Cl. G06T 7/73; G06N 3/04; G06N 3/08; G06K 9/46; G06K 9/62; H04N 5/247; G06T 7/246

(52) U.S. Cl. CPC G06T 7/74; G06N 3/0454; G06N 3/08; G06K 9/46; G06T 2207/20081; H04N 5/247; G06T 7/248; G06T 2207/30112; G06T 2207/20084; G06K 9/6215

(57) ABSTRACT

The present disclosure provides an article positioning method and system, which can achieve visual tracking and positioning of articles. The method includes: when each article enters a conveying queue, identifying an appearance attribute of the article through a monitoring camera to determine identification information of the article; determining an article sequence of the conveying queue after the article is added according to the location of the article entering the conveying queue and the identification information of the article; and positioning the article in the conveying queue through the appearance attribute of each article and the article sequence.

### CROSS-REFERENCE TO RELATED APPLICATIONS

The present application is a continuation under 35 U.S.C. § 120 of International Application No. PCT/CN2018/079602, entitled “ARTICLE POSITIONING METHOD AND SYSTEM”, and filed on Mar. 20, 2018. The entire contents of the above-listed application are hereby incorporated by reference for all purposes.

### TECHNICAL FIELD

The present disclosure relates to the field of artificial intelligence, and in particular to an article positioning method and system.

### BACKGROUND AND SUMMARY

In transportation hub scenarios such as airports, train stations or the like, or in the logistics industry, the delivery of articles is often involved, such as consigning and sorting of baggages, parcel sorting, and so on.

At present, for the scenarios such as airports and train stations having baggage consignment requirements of customers, automated baggage sorting and tracking are mainly achieved by radio frequency identification by using radio frequency labels. However, the cost of radio frequency label identifiers is relatively high, and the efficiency is low.

For the logistics transportation industry, article sorting is mainly achieved by manually scanning bar codes or two-dimensional codes attached to the outer packages of the articles by a scanning device, or, by automatically scanning the bar codes or the two-dimensional codes within 360 degrees all around through a special device. The manual sorting mode has the problems of large labor cost and low efficiency while the automated sorting mode costs relatively higher and has the problem of possible identification failure due to the shielding of the bar codes or the two-dimensional codes so that manual participation is still required in this situation which causes low efficiency.

Therefore, there is no better article tracking and positioning method at present.

To overcome the problems in the related art, the present disclosure provides an article positioning method and system, which can realize visual tracking and positioning of articles.

According to a first aspect of embodiments of the present disclosure, an article positioning method is provided, applied to an article positioning system, including: when each article enters a conveying queue, identifying an appearance attribute of the article through a monitoring camera to determine identification information of the article; determining an article sequence of the conveying queue after the article is added according to the location of the article entering the conveying queue and the identification information of the article; and positioning the article in the conveying queue through the appearance attribute of each article and the article sequence.

According to a second aspect of embodiments of the present disclosure, an article positioning system is provided, including:

at least one camera, configured to identify an appearance attribute of an article; and
a processor, connected with the at least one camera and configured to: when each article enters a conveying queue, identify the appearance attribute of the article through the at least one camera to determine identification information of the article; determine an article sequence of the conveying queue after the article is added according to the location of the article entering the conveying queue and the identification information of the article; and position the article in the conveying queue through the appearance attribute of each article and the article sequence.

According to a third aspect of embodiments of the present disclosure, a computer program product is provided. The computer program product includes a computer program executable by a programmable apparatus, and the computer program has a code part for executing the method in any item of the first aspect mentioned above when being executed by the programmable apparatus.

The technical solutions provided by the embodiments of the present disclosure may include the following beneficial effects:

in the embodiments of the present disclosure, when the article enters the conveying queue, an appearance attribute of the article can be identified by a camera to obtain the identification information of the article, and then the article sequence of the conveying queue after the article is added is determined according to the location of the article entering the conveying queue and the identification information of the article. Then, during the process of article positioning, the article can be tracked and positioned through the appearance attribute of the article and the article sequence of the conveying queue. In this way, article positioning and tracking can be realized by simply arranging cameras, and the visualization of the image of the article is at any time realized while the cost is reduced, and furthermore, the positioning accuracy in an article transportation process is improved by combining the article sequence of the conveying queue with the appearance attribute of the article.

### BRIEF DESCRIPTION OF THE DRAWINGS

The drawings are used for providing a further understanding of the present disclosure and constitute a part of the specification. The drawings, together with the following specific embodiments, are used for explaining the present disclosure, but are not intended to limit the present disclosure. In the drawings:

FIG. 1 is a flow diagram of an article positioning method shown according to an exemplary embodiment;

FIG. 2 is a schematic diagram of conveying articles via a conveyor belt shown according to an exemplary embodiment;

FIG. 3 is a schematic diagram of updating an article sequence on a conveyor belt shown according to an exemplary embodiment;

FIG. 4 is a block diagram of an article positioning system shown according to an exemplary embodiment.

### DETAILED DESCRIPTION OF THE DRAWINGS

The specific embodiments of the present disclosure will be described in detail below in combination with the drawings. It should be understood that the specific embodiments described herein are merely used for illustrating and explaining the present disclosure, rather than limiting the present disclosure.

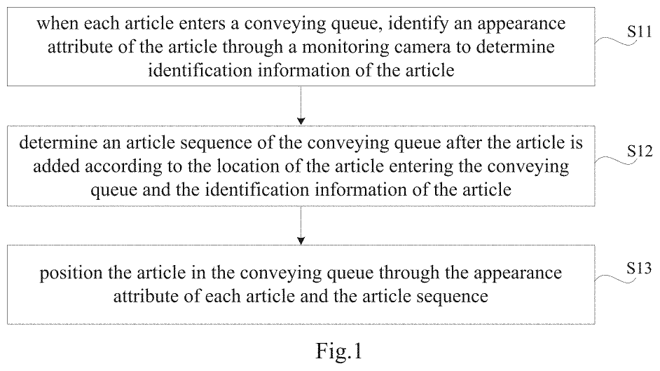

Please refer to FIG. 1, and FIG. 1 is a flow diagram of an article positioning method shown according to an exemplary embodiment. As shown in FIG. 1, the method includes the following steps.

Step S11: when each article enters a conveying queue, an appearance attribute of the article is identified through a monitoring camera to determine identification information of the article.

The conveying queue is a queue formed when the articles are queued for conveying, and after the first article to be transported is added to the conveying queue, the articles to be transported can be continuously added to the conveying queue. When each article (including the first article added to the conveying queue) enters the conveying queue, the identification information of the article can be determined by identifying the appearance attribute of the article. The identification information is a unique identifier of the article, and the identification information of different articles is different.

The identification information of the article can correspond, for example, to the identity information of an owner of the article. Taking the article as a baggage for the example, the identification information of the article can include an identity card number, riding information, and the like of the owner of the article. The appearance attribute of the article is used for describing the appearance of the article, and the appearance attribute of the article can include one or more of a category attribute, a color attribute, a size attribute, a shape attribute, a material attribute, and the like.

Since the cost of positioning the article in the conveying queue by scanning the identification information of the article through a scanning device is relatively high, in order to reduce the cost and visually position the article in the conveying queue, the embodiment of the present disclosure proposes to associate the appearance attribute of the article with the identification information of the article, so as to use the appearance attribute of the article as one of the reference factors for positioning the article in the conveying queue. The appearance attribute of the article can be captured by a camera, thereby being convenient and fast.

In one embodiment, the step of associating the appearance attribute of the article with the identification information of the article includes the following steps:

obtaining the identification information and the appearance attribute of the article for each article that is about to enter the article conveying queue; and
associating the obtained appearance attribute with the identification information of the corresponding article;
correspondingly, the step of identifying an appearance attribute of the article through a monitoring camera to determine the identification information of the article includes:
identifying the appearance attribute of the article through the monitoring camera; and
determining the identification information of the article according to the identified appearance attribute and the incidence relation between the appearance attribute and the identification information.

Before the article enters the conveying queue, the identification information and the appearance attribute of the article are obtained at first, and the identification information and the appearance attribute of the same article are associated. The identification information of the article can be obtained by scanning the article through a scanning device, and can also be obtained by collecting an image of the article through a camera. The appearance information of the article can be obtained by collecting the image of the article through a camera. Associating the identification information of the article with the appearance attribute means to establish a binding relationship between the identification information of the article and the appearance attribute so that the identification information of the article can be identified through the appearance attribute of the article when the article is about to enter the conveying queue, and an article sequence of the conveying queue can be determined when the article is added to the conveying queue subsequently.

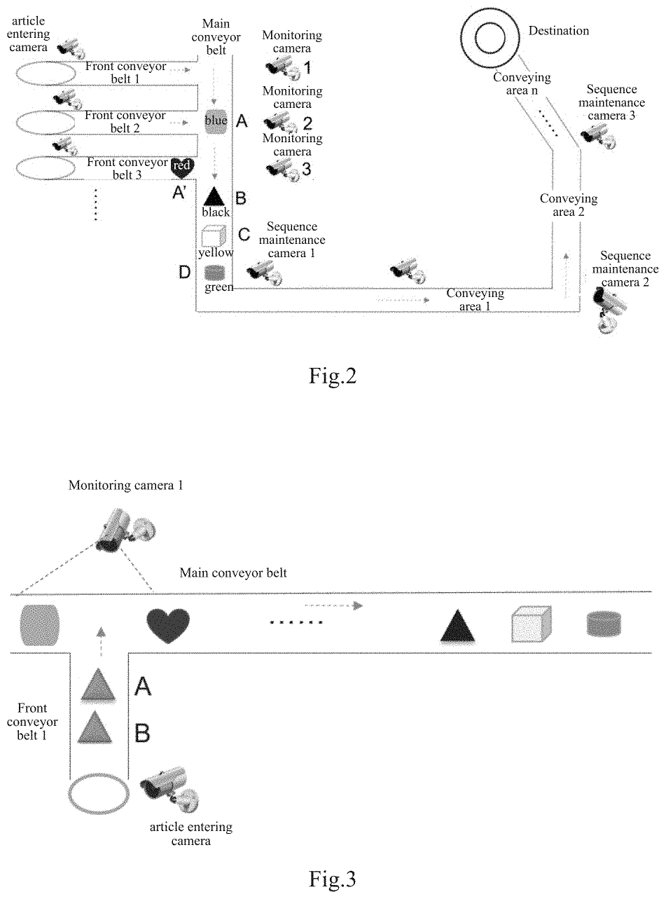

Exemplarily, referring to FIG. 2, the article conveying queue is a queue formed by articles in a conveying area of a main conveyor belt. The conveying area of the main conveyor belt communicates with the conveying area of one or more front conveyor belts, and the articles in the conveying area of the front conveyor belt are the articles which are about to enter the article conveying queue. In order to conveniently position an article, before the article is placed on the front conveyor belt, a two-dimensional code on the surface of the article is scanned by a scanning device (not shown in FIG. 2) to obtain the identification information of the article, or the article is numbered to obtain the identification information of the article. At the same time, the article is photographed by an article entering camera to obtain the appearance attribute of the article.

Then, the obtained identification information and the appearance attribute are bound to obtain the incidence relation between the identification information of the article and the appearance attribute of the article. For each article placed on the front conveyor belt, the identification information and the appearance attribute of the article on the front conveyor belt can be bound by referring to the above method.

When the article on the front conveyor belt is about to be conveyed to the main conveyor belt, the appearance attribute of the article is identified by cameras around the main conveyor belt, and the identification information of the article is determined according to the identified appearance attribute and the incidence relation established by the above binding method.

As shown in FIG. 2, when a heart-shaped article enters the front conveyor belt 3, the appearance attribute of the heart-shaped article is identified by an article entering camera, and is bound to identification information A′. When the heart-shaped article is about to enter the main conveyor belt, the appearance attribute of the heart-shaped article is identified through the monitoring camera 3, and the identification result includes, for example, a heart shape, and then the appearance attribute is compared with each appearance attribute in one or more newly established incidence relations, and the identification information associated with the consistent appearance attribute is A′.

By binding the appearance attribute and the identification information for each article entering the conveyor belt, each article in the conveying area can have the corresponding incidence relation between the identification information and the appearance attribute, and then when the article is about to enter the conveying queue or in a subsequent conveying process, the identification information of the article can be obtained by shooting the appearance attribute of the article through a monitoring camera, and possible manners are described below.

In one embodiment, the appearance attribute includes at least one of a category attribute, a color attribute, a size attribute, a shape attribute and a material attribute, and correspondingly, the step of identifying an appearance attribute of the article through a monitoring camera to determine the identification information of the article includes: identifying the article under each appearance attribute dimension through the monitoring camera, and determining a confidence coefficient of the identification result; and preforming similarity comparison on the identification result and the confidence coefficient under each appearance attribute dimension with the appearance attributes in the incidence relation to determine the identification information of the article.

In the present disclosure, the appearance attributes of multiple dimensions can be integrated to determine the identification information of the article, and the more dimensions of the appearance attributes are, the more accurate the identification result is. However, when the appearance attribute of the article is identified through the image captured by the monitoring camera, the identification result is often affected by factors such as the deployment position of the monitoring camera, the light, the angle, and the deformation of the article in the conveying process, and therefore, a confidence coefficient of the identification result is output when the appearance attribute of the article is identified, and the confidence coefficient is used as a factor to determine the identification information of the article. For the way of identification in various appearance attribute dimensions, the embodiment of the present disclosure does not limit it, and the possible manners are described below.

A method for identifying the category attribute includes, for example, performing identification, for example, by classifying the category features of the article such as a pull rod, a handle, a strap and the like, so the category of the article is determined by identifying whether the article has these features through the image, and meanwhile, a confidence coefficient can be judged and given; or, the method includes, for example, after training a large number of article images based on deep learning, performing category judgment based on an article category neural network identification model, and obtaining a confidence coefficient.

A method for identifying the color attribute can include, for example, obtaining a color value and a confidence coefficient of the article based on similarity comparison between a pixel color value of the article in the image and a reference color; or, after training a large number of article images based on deep learning, the method includes performing color judgment based on an article color neural network identification model, and obtaining a confidence coefficient.

A method for identifying the size attribute includes, for example, analyzing images based on parameters such as the own focal length, the angle, the resolution and the like of the monitoring camera to obtain an approximate size of the article, such as about 50 cm in length, 40 cm in width and 40 cm in height; because the numerical values may be inaccurate due to the shooting from different angles, the method also includes obtaining a confidence coefficient according to the location and the pixel value size and the like of the article in the image.

A method for identifying the shape attribute includes, for example, performing identification by classifying the designated shape features of a article, such as a cuboid, a cube, a cylinder and the like on the whole, and obtaining a confidence coefficient; or, after training a large number of article images based on deep learning, the method includes performing a judgment for classification on the shape similarity based on an article shape neural network identification model, and obtaining a confidence coefficient.

A method for identifying the material attribute includes, for example, performing identification by classifying the designated texture features of the article, such as plastic, canvas, paper and the like, and obtaining a confidence coefficient; or, after training a large number of article images based on deep learning, the method includes performing a judgment for classification on the material similarity based on an article texture material neural network identification model, and obtaining a confidence coefficient.

After the monitoring camera respectively identifies the article under each appearance attribute dimension, the confidence coefficient of the identification result can be determined. For example, as for a cuboid with the features of a pull rod and four universal rollers, its confidence coefficient being a draw-bar box may be 85%, and the confidence coefficient being a software bag is 65%.

The multi-dimensional appearance attribute of the article can be characterized by a vector space model, and each article corresponds to a feature vector, so the identification result can be compared with the identification result during the binding or the result identified by the camera in front of the current camera by using a vector similarity comparison method, for example, an Euclidean distance, cosine similarity or other similarity comparison methods. The identification information corresponding to the identified appearance attribute can be determined according to the comparison result. Similarly, other cameras on the main conveyor belt in FIG. 2 can also identify the appearance attribute of the article through the above method.

In view of the fact that the articles of different owners may have the same appearance attribute, in this case, the embodiment of the present disclosure proposes that the sequence of the articles entering the article positioning system is one of the consideration factors, and thus the step S11 can include the following steps:

when each article enters the conveying sequence, identifying the appearance attribute of the article through the monitoring camera; and
determining the identification information of the article according to the appearance attribute of the article and the sequence of the article entering the article positioning system.

The sequence of the articles entering the article positioning system can be determined according to the moment when the article enters the front conveyor belt. As shown in FIG. 3, two gray triangle articles (according to a successive sequence, the identification information is A and B respectively) enter the front conveyor belt 1 successively. Then it may not accurately distinguish which article is A and which article is B if just through the appearance attributes. Therefore it can be accurately determined that the gray triangle firstly entering is A and the gray triangle secondly entering is B in combination with the appearance attributes and the successive sequence of the two articles entering the front conveyor belt 1.

Step S12: an article sequence of the conveying queue after the article is added is determined according to the location of the article entering the conveying queue and the identification information of the article.

In the embodiment of the present disclosure, the article sequence of the conveying queue is recorded, and as shown in FIG. 2, in the conveying area of the main conveyor belt, the article sequence on the current main conveyor belt is A (blue cylinder), B (black triangle), C (Yellow square) and D (green cylinder). After the identification information of the article is bound with the appearance attribute of the article, the article enters the front conveyor belt. When a plurality of front conveyor belts are aggregated to one main conveyor belt, the image is needed to be captured by the monitoring camera entering the main conveyor belt to determine the location of the article entering the conveying queue, and the article sequence on the main conveyor belt is updated based on the location of the article entering the conveying queue.

Taking FIG. 2 as an example, after a red heart-shaped article on the front conveyor belt 3 enters the main conveyor belt, the article sequence on the main conveyor belt is updated as A (blue cylinder), A′ (red heart shape), B (black triangle), C (yellow square) and D (green cylinder).

In the embodiment of the present disclosure, the situation is considered that in a longer distance conveying process, the article may be blocked or overturned at a conveying transfer location or turning location, resulting in a change of the article sequence. In order that the identified article sequence is consistent with a real-time article sequence, so as to accurately position the article, the embodiment of the present disclosure proposes to continuously detect whether the article sequence changes through sequence maintenance cameras to maintain the accuracy of the article sequence.

In one embodiment, the sequence maintenance cameras are distributed at corners of the article conveying area. Continuing to refer to FIG. 2, three sequence maintenance cameras are provided: a sequence maintenance camera 1, a sequence maintenance camera 2, and a sequence maintenance camera 3, which are respectively distributed at the corners of the conveyor belt.

The step of maintaining the accuracy of the article sequence through the sequence maintenance cameras includes the following steps:

identifying the appearance attributes of the articles in sequence through the sequence maintenance cameras in the conveying process of the articles in the conveying queue;
comparing the identified appearance attributes with the appearance attributes of the corresponding articles in the article sequence in sequence to determine whether the current conveying sequence is consistent with the article sequence; and
if the current conveying sequence is inconsistent with the article sequence, updating the article sequence according to the current conveying sequence.

Based on the identification of the images captured by the sequence maintenance cameras, when inconsistency is discovered through the identification of the appearance attributes of the articles on the current conveyor belt and the comparison with the article sequence and the attributes maintained in the system, update is performed.

Taking FIG. 2 as an example, the article sequence on the current main conveyor belt is A (blue cylinder), B (black triangle), C (yellow square) and D (green cylinder). The sequence maintenance camera 2 identifies that the black triangular article is located behind the blue cylindrical article, which is inconsistent with the recorded article sequence, and therefore, the recorded article sequence is updated as A (blue cylinder), B (black triangle), C (yellow square) and D (green cylinder).

Step S13: the article in the conveying queue is positioned through the appearance attribute of each article and the article sequence.

Taking a baggage check-in scenario as an example, during baggage sorting, positioning an article means to determine the identification information of the baggage at each location to correctly convey the baggage to the corresponding aircraft for consignment; or, when a passenger is waiting for his or her baggage, positioning an article means to determine the identification information and the location of each baggage on the conveyor belt so that each passenger can know the current location of his own baggage.

In order to accurately position articles and reduce the cost, the articles in the conveying queue are positioned in combination with the appearance attributes and the obtained article sequence in the present disclosure. Firstly, the images of the articles are collected by cameras distributed on the surrounding of the main conveyor belt to obtain the appearance attributes of the articles, and then, due to the situation that the appearance attributes may be the same or similar, the article sequence is further combined to accurately position the articles in the conveying queue.

Since the articles may be the same or similar, the followings respectively illustrate methods dealing with the situation whether the articles have similar appearance attributes during the identification of the appearance attributes.

The first case: there are no articles with similar appearance attributes. The identification information of the articles can be directly determined through the appearance attributes, and the locations of the articles can be obtained by querying the article sequence.

The second case: there are articles with similar appearance attributes, and the step S13 includes:

comparing the appearance attributes of the target article, at least one article located in front of the target article, and at least one article located behind the target article with the appearance attributes corresponding to the article sequence to determine the identification information and the current location of the target article.

When there are multiple articles having almost the same appearance attribute in the conveying queue, it is necessary to combine the appearance attributes of the articles in front of and behind the target article (front, middle, and back) to compare them with the attributes of the articles in the conveying queue to determine the target article. If the appearance attributes of the front, middle and back articles still have very high similarity, the article in front of the front article and the article behind the back article are added, and then these five articles in total are used to compare, and so on to achieve the positioning of the target article.

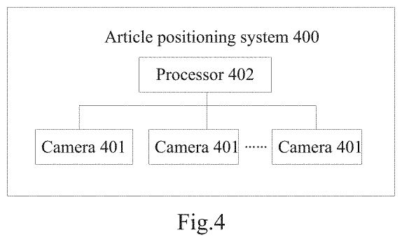

Referring to FIG. 4, based on the same inventive concept, the present disclosure provides an article positioning system 400, and the article positioning system 400 includes: at least one camera 401, configured to identify an appearance attribute of an article; and a processor 402, connected with the at least one camera 401 and configured to: when each article enters a conveying queue, identify the appearance attribute of the article through the at least one camera 401 to obtain identification information of the article; determine an article sequence of the conveying queue after the article is added according to the location of the article entering the conveying queue and the identification information of the article; and position each article in the conveying queue through the appearance attribute of each article and the article sequence.

Optionally, the processor 402 is further configured to:

obtain the identification information and the appearance attribute of the article for each article that is about to enter the article conveying queue;
associate the obtained appearance attribute with the identification information of the corresponding article;
identify the appearance attribute of the article through the at least one camera 401; and determine the identification information of the article according to the identified appearance attribute and the incidence relation between the appearance attribute and the identification information.

Optionally, the at least one camera 401 includes sequence maintenance cameras, and the processor 402 is further configured to:

identify the appearance attributes of the articles in sequence through the sequence maintenance cameras in the conveying process of the articles in the conveying queue;
compare the identified appearance attributes with the appearance attributes of the corresponding articles in the article sequence in sequence to determine whether the current conveying sequence is consistent with the article sequence; and
if the current conveying sequence is inconsistent with the article sequence, update the article sequence according to the current conveying sequence.

Optionally, the sequence maintenance cameras are distributed at corners of an article conveying area.

Optionally, the appearance attribute includes at least one of a category attribute, a color attribute, a size attribute, a shape attribute and a material attribute, and the processor 402 is configured to:

respectively identify the article under each appearance attribute dimension through the at least one camera 401, and determine a confidence coefficient of the identification result; and
perform similarity comparison on the identification result and the confidence coefficient under each appearance attribute dimension with the appearance attributes in the incidence relation to determine the identification information of the article.

Optionally, the conveying queue includes a target article to be positioned, and the processor 402 is configured to:

compare the appearance attributes obtained by the at least one camera of the target article, at least one article located in front of the target article and at least one article located behind the target article with the corresponding appearance attributes of the article sequence to determine the identification information and the current location of the target article.

Optionally, the processor 402 is configured to:

identify the appearance attribute of the article through the at least one camera 401 when each article enters the conveying queue; and
obtain the identification information of the article according to the appearance attribute of the article and the sequence of the article entering the article positioning system 400.

In another exemplary embodiment, a computer program product is further provided, the computer program product including a computer program executable by a programmable apparatus, and the computer program has a code part for executing the article positioning method mentioned above when being executed by the programmable apparatus.

The above embodiments are only used for describing the technical solutions of the present disclosure in detail, but the description of the above embodiments is only used for helping to understand the method of the present disclosure and its core ideas, and should not be construed as limiting the present disclosure. Modifications or replacements easily conceivable to those skilled in the art within the technical scope disclosed by the present disclosure shall all fall within the protection scope of the present disclosure.

1. An article positioning method, applied to an article positioning system, comprising:
identifying an appearance attribute of an article through a monitoring camera to determine identification information of the article when each article enters a conveying queue;
determining an article sequence of the conveying queue after the article is added according to a location of the article entering the conveying queue and the identification information of the article; and
positioning the article in the conveying queue through the appearance attribute of each article and the article sequence.

2. The article positioning method according to claim 1, wherein before the step of when each article enters the conveying queue, identifying the appearance attribute of the article through the monitoring camera to determine the identification information of the article, the method further comprises:
obtaining the identification information and the appearance attribute of the article for each article that is about to enter the article conveying queue; and
associating the obtained appearance attribute with the identification information of the corresponding article;
the step of identifying an appearance attribute of the article through the monitoring camera to determine the identification information of the article comprises:
identifying the appearance attribute of the article through the monitoring camera; and
determining the identification information of the article according to the identified appearance attribute and an incidence relation between the appearance attribute and the identification information.

3. The article positioning method according to claim 1, wherein the method further comprises:
identifying the appearance attributes of the articles in sequence through sequence maintenance cameras in a conveying process of the articles in the conveying queue;
comparing the identified appearance attributes with the appearance attributes of the corresponding articles in the article sequence in sequence to determine whether the current conveying sequence is consistent with the article sequence; and
if the current conveying sequence is inconsistent with the article sequence, updating the article sequence according to the current conveying sequence.

4. The article positioning method according to claim 3, wherein the sequence maintenance cameras are distributed at corners of an article conveying area.

5. The article positioning method according to claim 2, wherein the appearance attribute comprises at least one of a category attribute, a color attribute, a size attribute, a shape attribute and a material attribute, and the step of identifying an appearance attribute of the article through a monitoring camera to determine the identification information of the article comprises:
respectively identifying the article under each appearance attribute dimension through the monitoring camera, and determining a confidence coefficient of the identification result; and
performing a similarity comparison on the identification result and the confidence coefficient under each appearance attribute dimension with the appearance attributes in the incidence relation to determine the identification information of the article.

6. The article positioning method according to claim 1, wherein the conveying queue comprises a target article to be positioned, and the step of positioning the target article through the appearance attribute of each article and the article sequence comprises:
comparing the appearance attributes of the target article, at least one article located in front of the target article and at least one article located behind the target article with the appearance attributes corresponding to the article sequence to determine the identification information and the current location of the target article.

7. The article positioning method according to claim 1, wherein the step of when each article enters the conveying queue, identifying the appearance attribute of the article through the monitoring camera to determine the identification information of the article comprises:
identifying the appearance attribute of the article through the monitoring camera when each article enters the conveying queue; and
determining the identification information of the article according to the appearance attribute of the article and the sequence of the article entering the article positioning system.

8. An article positioning system, comprising:
at least one camera, configured to identify an appearance attribute of an article; and
a processor, connected with the at least one camera and configured to: when each article enters a conveying queue, identifying the appearance attribute of the article through the at least one camera to determine identification information of the article; determine an article sequence of the conveying queue after the article is added according to a location of the article entering the conveying queue and the identification information of the article; and position the article in the conveying queue through the appearance attribute of each article and the article sequence.

9. The article positioning system according to claim 8, wherein the processor is further configured to:
obtain the identification information and the appearance attribute of the article for each article that is about to enter the article conveying queue;
associate the obtained appearance attribute with the identification information of the corresponding article;
identify the appearance attribute of the article through the at least one camera; and
determine the identification information of the article according to the identified appearance attribute and an incidence relation between the appearance attribute and the identification information.

10. The article positioning system according to claim 8, wherein the at least one camera comprises sequence maintenance cameras, and the processor is further configured to:
identify the appearance attributes of the articles in sequence through the sequence maintenance cameras in a conveying process of the articles in the conveying queue;
compare the identified appearance attributes with the appearance attributes of the corresponding articles in the article sequence in sequence to determine whether the current conveying sequence is consistent with the article sequence; and
if the current conveying sequence is inconsistent with the article sequence, update the article sequence according to the current conveying sequence.

11. The article positioning system according to claim 10, wherein the sequence maintenance cameras are distributed at corners of an article conveying area.

12. The article positioning system according to claim 9, wherein the appearance attribute comprises at least one of a category attribute, a color attribute, a size attribute, a shape attribute and a material attribute, and the processor is configured to:
respectively identify the article under each appearance attribute dimension through the at least one camera, and determine a confidence coefficient of the identification result; and
perform a similarity comparison on the identification result and the confidence coefficient under each appearance attribute dimension with the appearance attributes in the incidence relation to determine the identification information of the article.

13. The article positioning system according to claim 8, wherein the conveying queue comprises a target article to be positioned, and the processor is configured to:
compare the appearance attributes obtained by the at least one camera of the target article, at least one article located in front of the target article and at least one article located behind the target article with the appearance attributes corresponding to the article sequence to determine the identification information and the current location of the target article.

14. The article positioning system according to claim 8, wherein the processor is configured to:
identify the appearance attribute of the article through the at least one camera when each article enters the conveying queue; and
obtain the identification information of the article according to the appearance attribute of the article and the sequence of the article entering the article positioning system.

15. A computer program product, wherein the computer program product comprises a computer program executable by a programmable apparatus, and the computer program has a code part for executing the method in claim 1 when being executed by the programmable apparatus.
